(19) United States
(12) Patent Application Publication
(10) Pub. No.: US 2006/0288744 A1
(43) Pub. Date: Dec. 28, 2006

(54) Alarm lock

(76) Inventor: William Smith, Alameda, CA (US)

Correspondence Address: LAW OFFICE OF J. CURTIS EDMONDSON, P.O. BOX 571, CLAREMONT, CA, 91711, US

(21) Appl. No.: 11/169,494

(22) Filed: Jun. 28, 2005

(51) Int. Cl. E05B 67/24

(52) U.S. Cl. 70/38 B

(57) ABSTRACT

A electronic padlock is disclosed with remote control device. The electronic padlock has a tamper detection mechanism, a camera, and a speaker. The padlock can be remotely controlled using a remote device, such as a device similar to a garage door opener or a cell phone.

### BACKGROUND

This invention relates to locks, specifically to locks that are used to secure lockers or bicycles.

Locks are used to prevent unwanted people from obtaining access to areas without the permission of the owner. There are numerous designs for locks and their designs are well known in the arts. A padlock is one common design and is often used to secure lockers or used on chains to prevent bicycles from theft.

Most padlocks are passive. They fail to alert a person the lock is being tampered with or compromised. Consequently a person rarely discovers if a lock has been broken until long after it has occurred.

The present invention resolves that problem. It is an active device that alerts the owner of the lock by transmitting the status of the lock to the owner via a wireless channel. The lock incorporates an alarm feature to discourage tampering with the lock. In its preferred embodiment, the lock consists of a mechanism to open using a standard mechanical key entry system; a electronic mechanism for entry using a keypad; a tamper alert system with a flashing LED, a speaker, and a wireless status transmission system.

U.S. Pat. No. 6,401,501 discloses an electrically activated lock that is opened by a keypad. It lacks the ability to remotely notify the owner of the lock if it is compromised.

U.S. Pat. No. 6,826,935 discloses an mechanically and electrical activated lock with a remote status monitoring. It does not disclose a padlock design, nor the ability to remotely communicate with cellular devices.

U.S. Pat. No. 6,442,983 discloses a mechanical padlock with a digital programmable microprocessor interface. It does not disclose a remote monitoring of the lock.

U.S. Pat. No. 6,046,558 discloses a lock with a speaker. It does not disclose a mechanism for the remote monitoring of the lock.

U.S. Pat. No. 5,894,277 discloses an electrically activated lock that includes a remote monitoring device, a speaker, and a keypad activation mechanism. It does not disclose the ability to open the lock mechanically.

U.S. Pat. No. 6,137,409 discloses a device with a keypad and remote status monitor. It does not disclose a locking mechanism.

US Patent Application Publication 2005/011238 discloses a lock that is electrically activated with a remote device. If does not disclose a device that provides tamper detection with a warning speaker.

Ambient Weather (www.ambientweather.com) discloses an electrically activated lock with a remote control. It does not disclose a device with tamper detection.

LS Systems produces a high security lock with a motion activated alarm. It does not disclose remote monitoring.

None of the aforementioned patents teach the use of a padlock that incorporates a mechanical key opening device, a tamper alert device, and the ability to remotely monitor the status of the lock.

### SUMMARY OF THE INVENTION

The present invention discloses a novel padlock that provides both local and remote protection.

In the preferred embodiment the lock is of standard padlock design one may find on a gym or storage locker. It consists of the mechanism to open the lock using a key. It also incorporates a keypad to open the locker electronically. To deter tampering with the lock, it incorporates motion detection circuitry, an alarm, and a camera. To alert the owner of the lock, the lock also will transmit the status and a picture to the owner via a wireless connection.

### BRIEF DESCRIPTION OF THE DRAWINGS

FIG. 1 is a front view of the padlock depicting the keypad entry system.

FIG. 2 is a rear view of the padlock depicting the location of the speaker.

FIG. 3 is a front sectional view of the padlock with the front of the padlock removed showing the internal components.

FIG. 4 is a view of the padlock taken along the base.

FIG. 5 is a block diagram of the electronic system as incorporated in the padlock.

FIG. 6 is a flowchart describing opening and closing of the lock using the keypad interface.

FIG. 7 is a flowchart describing the tamper alert mechanism.

FIG. 8 is a flowchart describing the remote actuation of various lock functions.

### DETAILED DESCRIPTION

While describing the invention and its embodiments various terms will be used for the sake of clarity. These terms are intended to not only include the recited embodiments, but also all equivalents that perform substantially the same function, in substantially the same manner to achieve the same result.

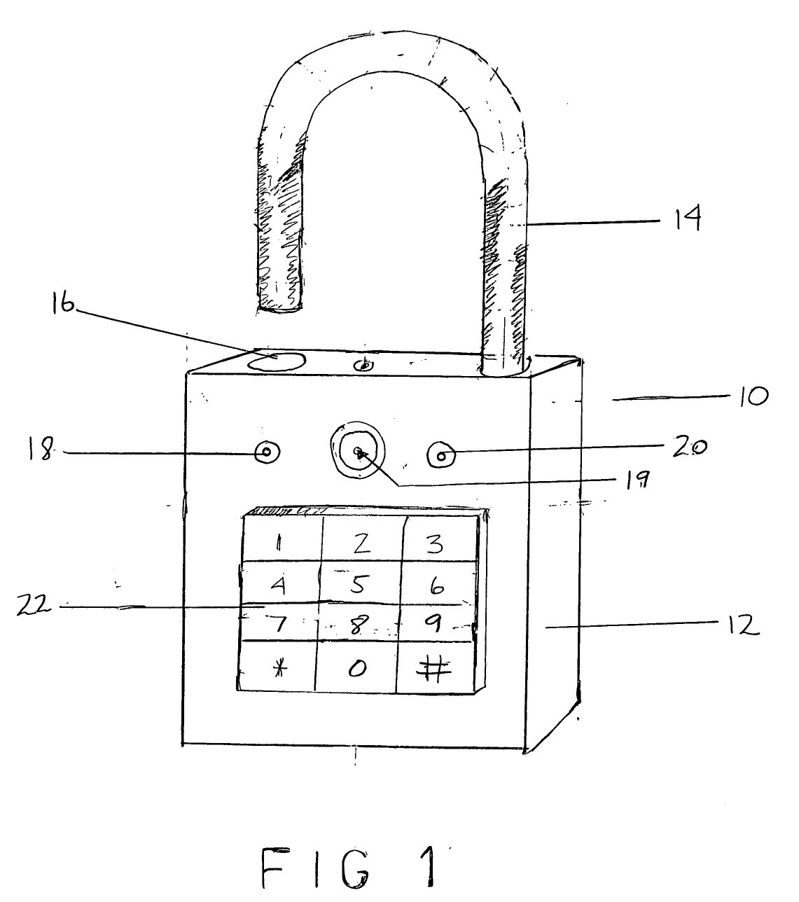

FIG. 1 shows a front view of a padlock 10. The padlock consists of a casing 12 and a cylindrically shaped shackle 14 and a hole 16 for receiving the shackle. The front of the padlock consists of a signal LED 18, a camera 19, battery indicator LED 20, a switch 49, and a keypad 22.

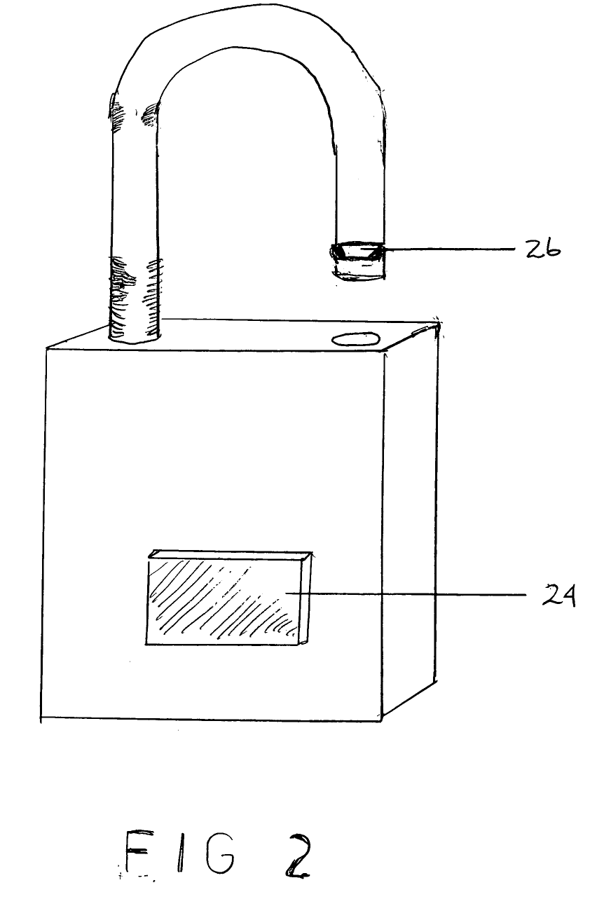

FIG. 2 is an opposite side view of the padlock 10 which incorporates a speaker 24 which may be of the standard magnetic paper cone variety or piezo electric. The shackle is shown in the open position with the notch 26 on the shackle.

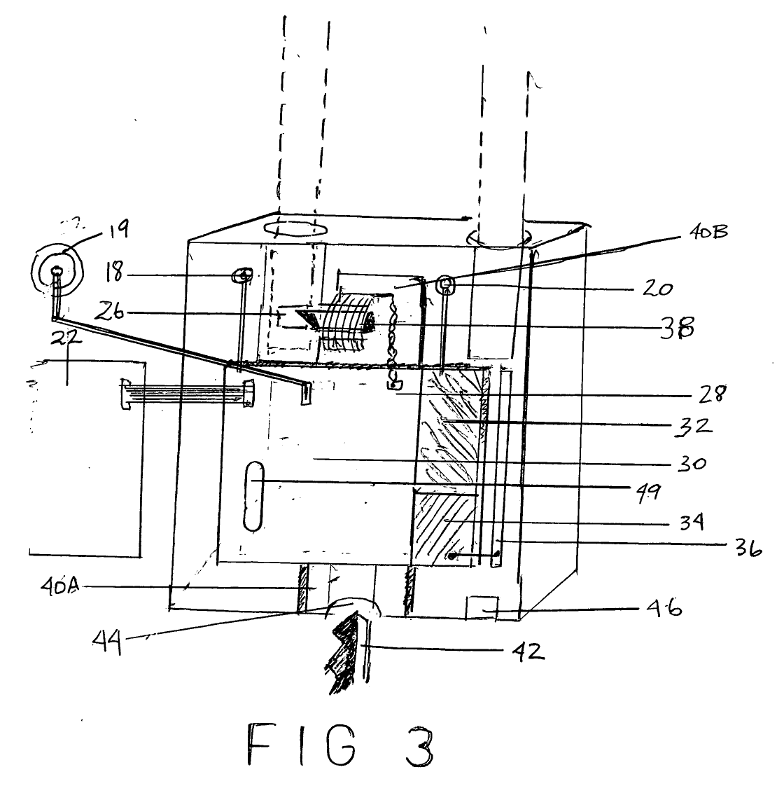

FIG. 3 is a front sectional view of the padlock 10 with the keypad 22 removed. The internal components consist of a circuit board 28 which contains the electronic subsystems: the padlock control circuitry 30, the power control circuitry 32, the wireless control circuitry 34, and an antenna 36. The padlock control circuitry 30 is connected to an electromagnetic actuator 38. The padlock control circuitry also powers the battery indicator LED 20 and the signal LED 18. The lock can also be actuated with a mechanical assembly 40A, 40B that is used in most traditional padlocks and that is actuated by a key 42 into key receptacle 44. Power to recharge the lock is applied at the power interface 46. Changes in motion, such as when the lock is tampered with, are detected using a mercury switch 48 or a similar device.

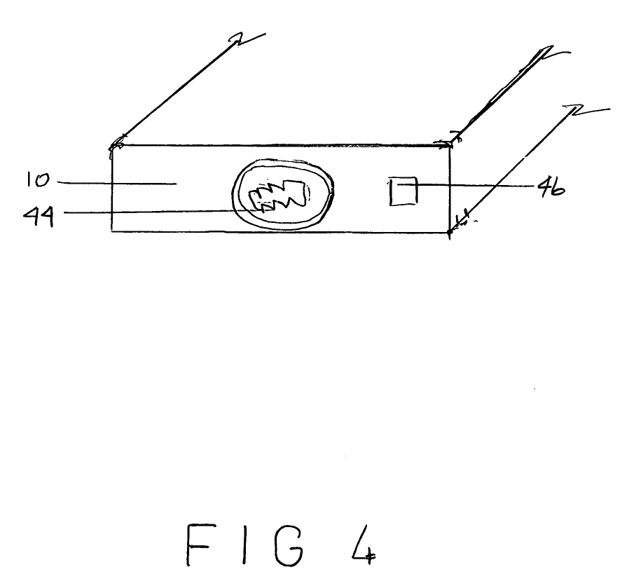

FIG. 4 is a base view of the padlock 10 showing the key receptacle and power interface 46.

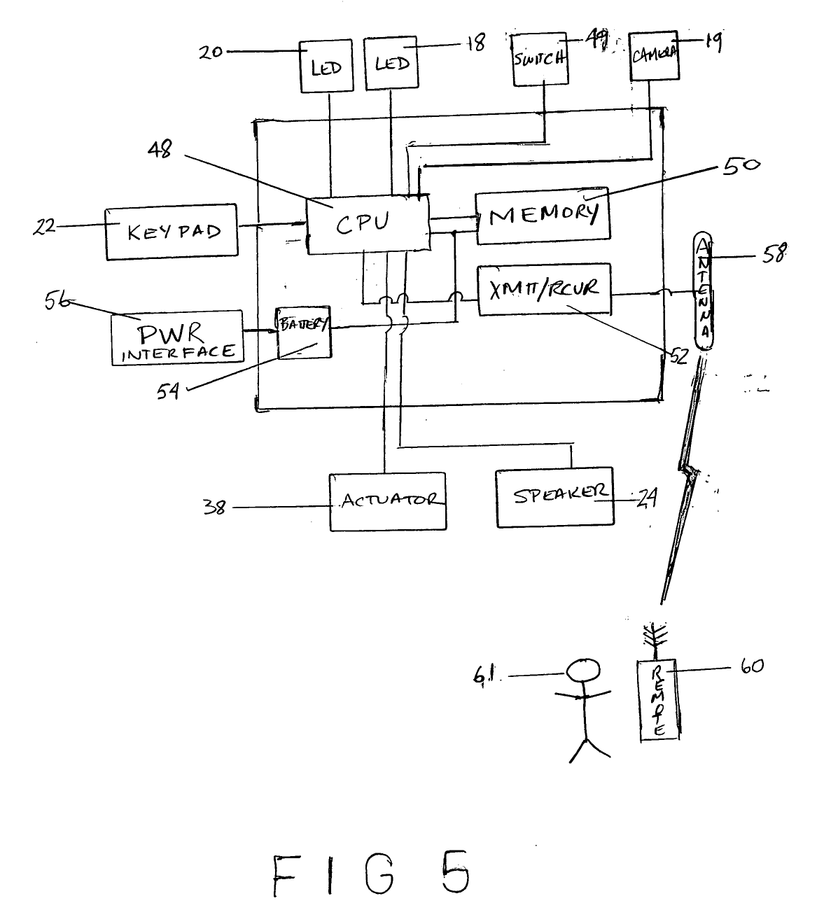

FIG. 5 depicts as a block diagram the major electronic subsystems. The CPU 48 is a commonly used microprocessor or microcontroller. The CPU 48 is connected to two major subsystems: the memory 50, the XMIT/RCVR subsystem 52; and a number of peripheral devices: the battery indicator LED 20, the signal LED 18, the switch 49, the digital camera 19, the keypad 22, the actuator 38, and speaker 24. The electronic subsystems and peripheral devices are powered by a internal battery 54 and a power supply interface 56. The XMIT/RCVR subsystem 52 is connected to an antenna 58 designed for the required frequency which interfaces to the remote 60.

The operation of the padlock 10 is controlled by the CPU 48 based on a computer program stored in memory 50. This leads to versatile operation of the padlock 10.

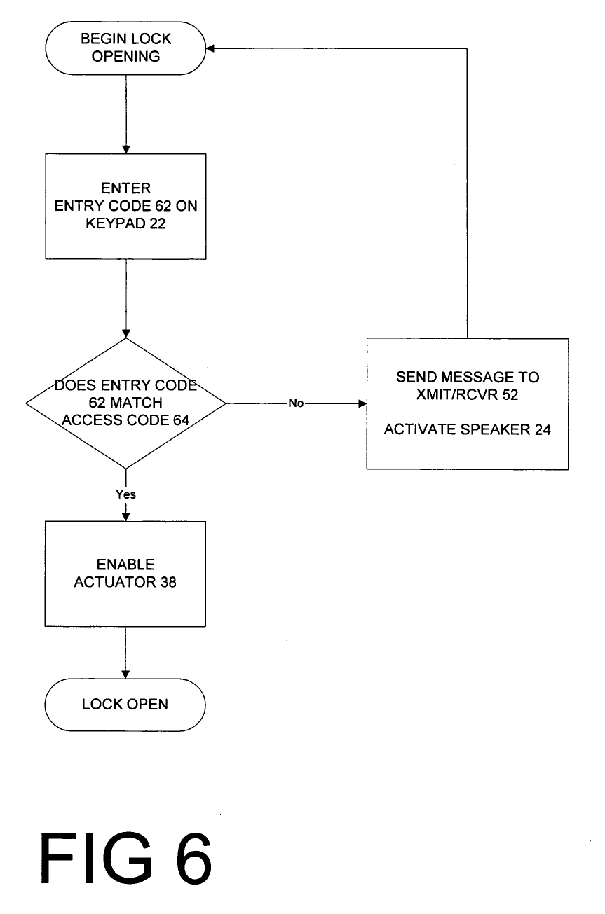

FIG. 6 is a flowchart showing the process of opening the lock using the electronic actuator. A person trying to open the padlock 10 enters an entry code 62 on the keypad 22. The CPU 48 receives the entry code 62 and compares it to a stored code 64 located in memory 50. If the entry code 62 matches the stored code 64 the CPU 48 engages the actuator 38. If the entry code 62 does not match the stored code 64 the CPU will send a message to the XMIT/RCVR 54, activate the speaker 24, and take a photo using the digital camera 19. The photo is stored in memory 50.

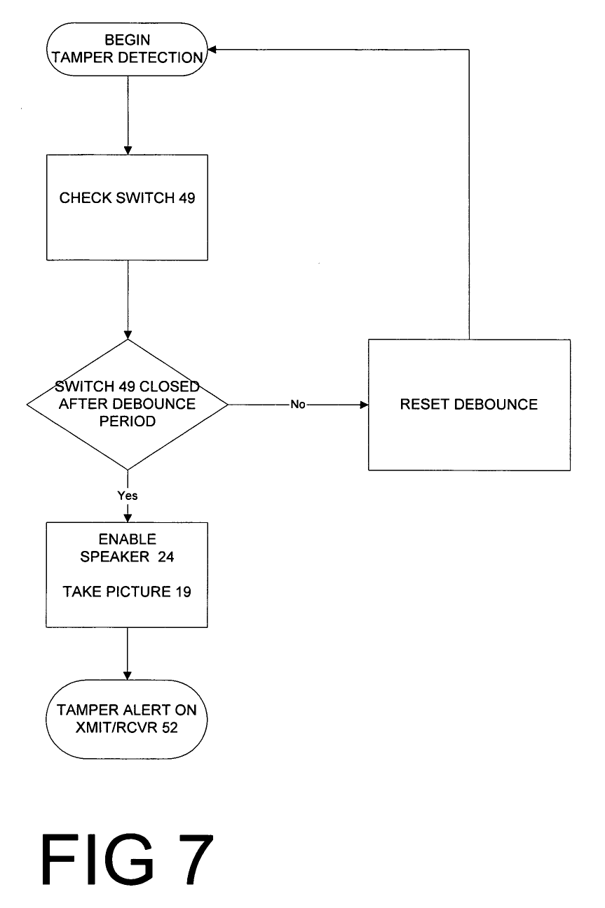

FIG. 7 is a flowchart showing the process of alerting the owner of the padlock 10 if it has been tampered. Switch 49 is checked to see if it has been closed. If it has not been closed then the CPU 48 performs other functions and checks at a later time. If the switch 49 has been closed, which indicates tampering, the speaker 24 is activated, a picture is taken with camera 19, and a message is sent to XMIT/RCVR 52. XMIT/RCVR 52 then transmits the message to remote 60 via the antenna 58. The message may also contain the picture from the camera 19.

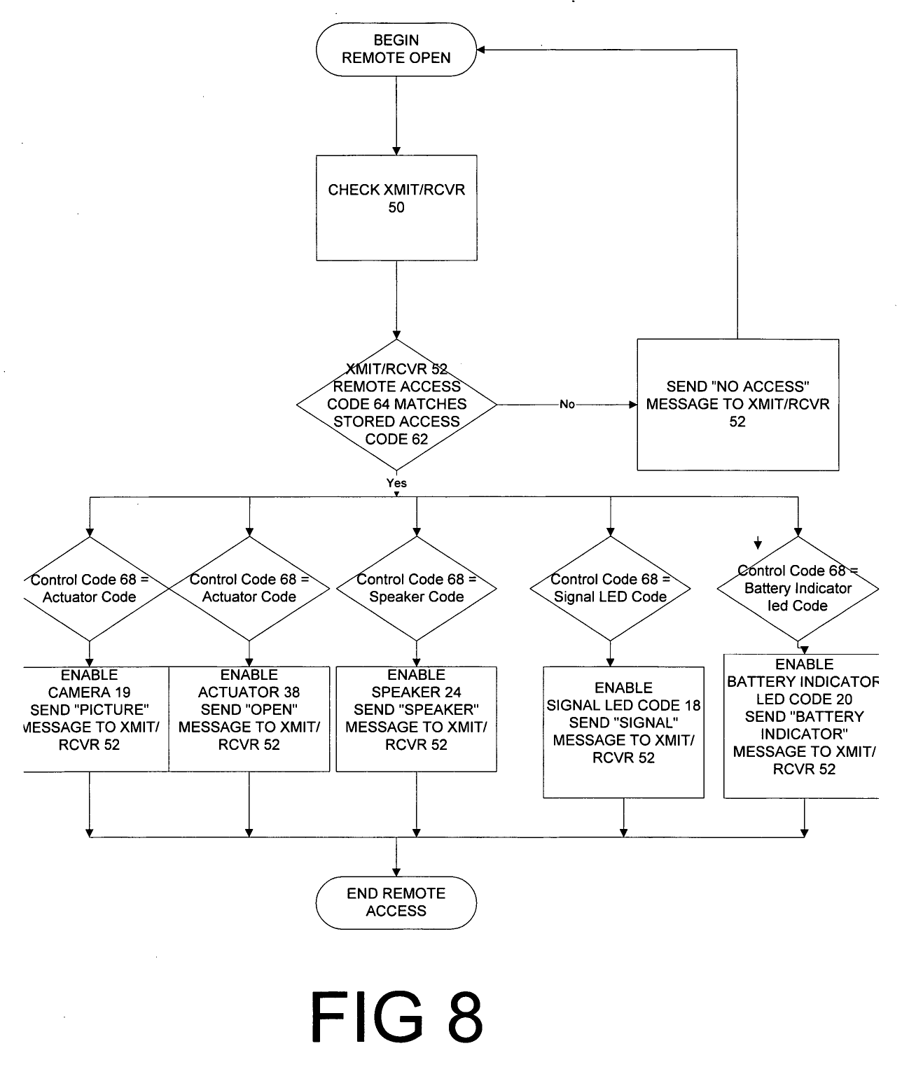

FIG. 8 is a flowchart showing the process of remotely controlling the peripherals on the padlock 10. The remote user 61 enters a remote access code 66 and a control code 68 into remote 60. Remote 60 may be a device specially designed for this lock, or may be an off the shelf cell phone or laptop computer. Remote 60 transmits the remote access code 66 and a control code 68 to antenna 58 which is stored in XMIT/RCVR 52. CPU 48 takes the remote access code 66 and compares it to the stored code 64. If the remote access code 66 matches the stored code 64 then the control code 68 is read. If the control code 68 is equivalent to the enable actuator code then the actuator 38 is engaged to allow the shackle 14 to be opened. If the control code 68 is equivalent to the speaker actuator code then the speaker 20 is engaged which causes the speaker 20 to sound. If the control code 68 is equivalent to the signal LED code then the signal LED 18 is illuminated to allow the user to determine if the LED is operable. If the control code 68 is equivalent to the battery indicator LED code then the battery indicator LED 20 is illuminated to allow the user to determine if the LED is operable. If the control code 68 is equivalent to camera code then the camera 19 will take a picture.

It will be appreciated that those skilled in the art may devise numerous modifications and embodiments. For example, the remote access device can be a pager, in which case status information would only be displayed. Likewise, the padlock 10 could initiate a sound similar to “ring tones” or voice downloaded from a cell phone or laptop when the lock is opened or closed.

I claim:

1. A lock mechanism comprising:
a) a lock body defining all interior cavity;
b) a shackle connected to said lock body and movable to a locked position for securing an object between said shackle and lock body and an unlocked position for releasing said object secured therebetween;
c) a lock mechanism, disposed within the interior cavity including:
i) a rotatable member having it toothed section and operatively connected to said shackle for rotation between a first position, to secure said shackle in said locked position in said lock body, and a second position, to release said shackle for movement to said unlocked position, and
ii) a rotatable second member disposed adjacent to said first member and having a threaded section configured to intermesh and rotate with said toothed section of said first member, wherein said second member is rotated in a first direction to engage the lock mechanism and in a second direction to disengage the lock mechanism; and
d) an electronic lock mechanism, disposed within the interior cavity including:
i) a central processing unit (CPU), a memory module electrically connected to the CPU for storing instructions, a keypad electrically connected to the CPU for entering numbers and symbols, a battery indicator LED electrically connected to the CPU for indicating low power, a signal indicator LED electrically connected to the CPU for indicating the status of the lock, a motion detection switch electrically connected to the CPU for detecting movement of the lock, a camera for taking pictures connected to the CPU, a speaker electrically connected to the CPU creating an audio tone, a transmitter and receiver (XMIT/RCVR) module connected to the CPU and an antenna for externally interfacing with a remote control device, a power supply system for supply power to the electrically powered devices, and
ii) an actuator electrically connected to the CPU, said actuator having a wedge section, said wedge section operatively connected to said shackle in said lock body, a first position for said wedge section for movement to engage said shackle and a second position to release said shackle for movement to said unlocked position.

2. A lock mechanism of claim 1 wherein said transmitter and receiver (XMIT/RCVR) module and antenna are designed to operate on frequencies greater than 10 MHz.

3. A lock mechanism of claim 2 wherein said transmitter and receiver (XMIT/RCVR) module are selected from group consisting of: pager frequencies, cell phone frequencies, garage door frequencies.

4. A lock mechanism of claim 1 wherein said exterior is constructed from materials that do not interfere with signals from said antenna.

5. A lock mechanism of claim 4 wherein said exterior is constructed from stainless steel.

6. A lock mechanism of claim 1 wherein said motion detection switch is enabled when it is jarred by a human.

7. A lock mechanism of claim 1 wherein said speaker, when activated, produces a noise selected from a group consisting of an standard alarm sound, a ‘ring tone’ sound, a song, or human speech.

8. A lock mechanism of claim 7 wherein said sounds are stored in said memory.

9. A lock mechanism of claim 8 wherein said sounds are transferred to said memory via said transmitter and receiver (XMIT/RCVR) module.

10. A lock mechanism of claim 1 wherein said camera, when activated, takes a picture and transmits to a computing device.

11. A lock mechanism of claim 1 wherein said power supply is battery powered.

12. A lock mechanism of claim 11 wherein said battery is recharged externally.

13. A method for alerting the owner of a lock mechanism comprising:
detecting vibrations from when said lock mechanism is mishandled;
recording said flag in the memory of the CPU;
detecting the status of flag and if flag is set;
whereby a notice is sent to said owner to a remote device.

14. A method for controlling the functions of a lock mechanism comprising:
a remote device from which an access code and a control code is entered;
transmitting said access code and control code to said lock mechanism;
verifying said access code and if said access code matches a pre-set code;
determining which internal peripheral device in the lock mechanism is to be controlled.
whereby said peripheral is manipulated using the contents of the control code.
